(19) United States
(12) Patent Application Publication
(10) Pub. No.: US 2019/0005903 A1
(43) Pub. Date: Jan. 3, 2019

(54) DISPLAY DEVICE AND DRIVING METHOD THEREOF

(71) Applicants: HKC Corporation Limited, Shenzhen City (CN); Chongqing HKC Optoelectronics Technology Co., ltd., Chongqing (CN)

(72) Inventor: MINGLIANG WANG, Chongqing (CN)

(21) Appl. No.: 15/869,755

(22) Filed: Jan. 12, 2018

Related U.S. Application Data
(63) Continuation of application No. PCT/CN2017/100325, filed on Sep. 4, 2017.

(30) Foreign Application Priority Data
Jun. 30, 2017 (CN) 201710521104.0

(51) Int. Cl. G09G 3/36; G02F 1/1335

(52) U.S. Cl. CPC G09G 3/3607; G09G 2310/0264; G02F 1/133609; G02F 1/133603

(57) ABSTRACT

The present application discloses a display device and a driving method thereof. The display device includes a display panel, includes a plurality of pixels, the pixels comprising red sub-pixels, green sub-pixels, blue sub-pixels, and white sub-pixels; a backlight module, the backlight module disposed opposite to the display panel; wherein the backlight module includes a light source, the light source comprising a plurality of light emitting elements, including a first light emitting element, a second light emitting element, and a third light emitting element; and a driving module includes a processing unit for analyzing data of an image to be displayed; a detection unit for detecting and determining whether the image to be displayed being a pure color image or a color image; a control unit for controlling the light emission state of the plurality of light emitting elements to emit the light required for the image to be displayed.

### FIELD OF THE DISCLOSURE

The disclosure relates to a backlight design of the display device, and more particularly to a display device and driving method thereof.

### BACKGROUND

The pixels of the existing liquid crystal display panel are usually composed of three sub-pixels, that is, by R (red sub-pixels), G (green sub-pixels) and B (blue sub-pixels) three sub-pixels. With the development of liquid crystal display technology, there are new pixel composition and sub-pixels arrangement proposed, such as RGBW arrangement and so on. The RGBW arrangement is a pixel composed of four sub-pixels, that is, besides the conventional RGB three sub-pixels of a pixel, W sub-pixels (white sub-pixels) are additional added. There may be a plurality arrangement of sub-pixels in the RGBW pixels. As the W sub-pixels are increased in the RGBW pixels, this type of panel will make the image brighter when displaying image, the color of the image will be more vivid. However, as the addition of the W sub-pixels to the RGBW pixel, under the same transmittance status, in the same size of the display area, the ratio of the size of the individual sub-pixel is reduced in the same size display area. This also causes the luminance of panel is decreased when the panel displays a pure color (that is, to display the image of the RGB three sub-pixels individually). In the same gray scale, compared to the conventional RGB liquid crystal display panel, it will lead to that the desired performance of the display cannot be achieved.

Since the W pixel is introduced; the aperture ratios of R, G, and B are changed to 75% of the RGB three primary colors display panel. When displaying the pure color images, such as pure color images of pure red, pure green, pure blue, the luminance of the image displayed by the RGBW liquid crystal display panel is lower than the luminance of the image of the conventional RGB liquid crystal display, affecting the display performance, such problems need to be resolved.

### SUMMARY

In order to solve the above technical problems, an object of the present disclosure is to provide a backlight design of a display device, and more particularly, to a display device and a driving method thereof, it not only can improve the issue of insufficiently luminance of the pure color image, and not limited by the gray scale of the pure color image, but also can improve the color gamut and improve the contrast of the display image.

The object of the present application and the technical problem to be solved are by the following technical scheme. A display device according to the present application includes a display panel, including a plurality of pixels, each of the pixels including a first sub-pixel, a second sub-pixel, a third sub-pixel, and a fourth sub-pixel; a backlight module disposed opposite to the display panel; wherein the backlight module includes a light source, the light source includes a plurality of light emitting elements; each of the light emitting elements includes a first light emitting element, a second light emitting element, and a third light emitting element; a driving module includes: a processing unit for analyzing data of an image to be displayed; a detection unit for detecting and determining whether the image to be displayed being a pure color image or a color image; a control unit for controlling the light emission state of the plurality of light emitting elements to emit light required for the image to be displayed.

The purpose of the present application and the technical problem thereof can be further realized by the following technical measures.

In an embodiment of the present application, the plurality of light emitting elements are color light emitting diodes.

In an embodiment of the present application, the first light emitting element is a red light emitting element, the second light emitting element is a green light emitting element, and the third light emitting element is a blue light emitting element.

In an embodiment of the present application, the control unit controls the red light emitting diode, the green light emitting diode, and the blue light emitting diode to be turn on simultaneously or individually.

Another object of the present application is a driving method for a display device including: acquiring and analyzing gray scale data of first sub-pixels, second sub-pixels, third sub-pixels, and fourth sub-pixels of an image to be displayed by a processing unit; detecting and determining the image to be displayed being a pure color image or a color image by a detection unit; if the display image being the pure color image, at least one of a plurality of light emitting elements is controlled to be turned on by a control unit; if the display image being the color image, the plurality of light emitting elements being controlled to be turn on to emit white light by the control unit; wherein, the plurality of light emitting elements include red light emitting elements, green light emitting elements, and blue light emitting elements.

In an embodiment of the present application, the plurality of light emitting elements are color light emitting diodes.

In an embodiment of the present application, the plurality of light emitting elements include a first light emitting element, a second light emitting element, and a third light emitting element.

In an embodiment of the present application, the first light emitting element is a red light emitting diode, the second light emitting element is a green light emitting diode, and the third light emitting element is a blue light emitting diode.

In an embodiment of the present application, the control unit controls the red light emitting diode, the green light emitting diode, and the blue light emitting diode to be turn on simultaneously or individually.

In an embodiment of the present application, a turn on state and a turn off state of the first sub-pixels, the second sub-pixels, the third sub-pixels are corresponding to the turn on state and the turn off state of the red light emitting diode, the green light emitting diode, the blue light emitting diode, respectively.

In an embodiment of the present application, if a presented color of the pure color image is one color of red, green, and blue, the cores of one of the corresponding red light emitting elements, the green light emitting elements, and the blue light emitting elements are controlled to be turned on, the other light emitting elements are turned off by the control unit, and the sub-pixels corresponding to the cores and the white sub-pixels are turned on, to reveal and form the pure color image.

In an embodiment of the present application, if a presented color of the pure color image is a color formed by mixing at least two colors of red, green and blue, at least two of the corresponding red light emitting elements, the green light emitting elements, the blue light emitting elements are controlled to be turned on by the control unit, and the sub-pixels corresponding to the cores and the white sub-pixels are turned on, to reveal and form the pure color image.

In an embodiment of the present application, if the image to be displayed is the color image, the red light emitting elements, the green light emitting elements, and the blue light emitting elements are controlled to be turned on simultaneously by the control unit, to mix emitting light and emitting white light, the corresponding sub-pixels and the white sub-pixels are turned on.

Another display device provided by the present application includes: a display panel, including a plurality of pixels, the pixels including a first sub-pixel, a second sub-pixel, a third sub-pixel, and a fourth sub-pixel; a backlight module disposed opposite to the display panel; a driving module, including: a processing unit for analyzing data of an image to be displayed; a detection unit for detecting and determining whether the image to be displayed being a pure color image or a color image; a control unit for controlling the light emission state of the plurality of light emitting elements, to emit the light required for the image to be displayed; wherein the backlight module includes a light source, the light source including a plurality of light emitting elements, including a first light emitting element, a second light emitting element, and a third light emitting element; wherein the first light emitting element is a red light emitting element, the second light emitting element is a green light emitting element, the third light emitting element is a blue light emitting element; and wherein the control unit controls the red light emitting diode, the green light emitting diode, and the blue light emitting diode to be turn on individually or simultaneously.

The present disclosure can improve the issue of the insufficiently display luminance of the pure color image by the design of the light source of the backlight module to replace the conventional white light source, and is not limited by the gray scale of the pure color image, and to improve the color gamut and increase the contrast of the display image.

### BRIEF DESCRIPTION OF THE DRAWINGS

FIG. 1 is a schematic diagram of a RGB pixel structure in the embodiment.

FIG. 2 is a schematic diagram of a RGBW pixel structure in the embodiment.

FIG. 3 is a schematic view of a backlight module according to an embodiment of the present application.

FIG. 4 is a schematic view of a pixel display of a pure color image according to an embodiment of the present disclosure.

FIG. 5 is a schematic view showing a display device structure according to an embodiment of the present disclosure.

FIG. 6 is a driving flowchart of a display device according to an embodiment of the present disclosure.

FIG. 7 is a schematic diagram of a pixel structure of the pure color image according to an embodiment of the present disclosure.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the description of the disclosure, terms such as “center”, “transverse”, “above”, “below”, “left”, “right”, “vertical”, “horizontal”, “top”, “bottom”, “inside”, “outside”, etc. for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation with respect to the disclosure. Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the disclosure, unless otherwise indicated, the meaning of “plural” is two or more than two. In addition, the term “comprise” and any variations thereof are meant to cover a non-exclusive inclusion.

In the description of the disclosure, is should be noted that, unless otherwise clearly stated and limited, terms “mounted”, “connected with” and “connected to” should be understood broadly, for instance, can be a fixed connection, a detachable connection or an integral connection; can be a mechanical connection, can also be an electrical connection; can be a direct connection, can also be an indirect connection by an intermediary, can be an internal communication of two elements. A person skilled in the art can understand concrete meanings of the terms in the disclosure as per specific circumstances.

The terms used herein are only for illustrating concrete embodiments rather than limiting the exemplary embodiments. Unless otherwise indicated in the content, singular forms “a” and “an” also include plural. Moreover, the terms “comprise” and/or “include” define the existence of described features, integers, steps, operations, units and/or components, but do not exclude the existence or addition of one or more other features, integers, steps, operations, units, components and/or combinations thereof.

The drawings and description are to be regarded as illustrative in nature and not restrictive. In the figure, structures with similar structures are denoted by the same reference numerals. In addition, the dimensions and thickness of each of the components shown in the drawings are shown arbitrarily for purposes of understanding and ease of description, but this application is not limited.

In the drawings, the thickness of layers, films, panels, regions, etc. is exaggerated for clarity. In the drawings, the thickness of some layers and regions is exaggerated for the sake of understanding and ease of description. It will be understood that when an assembly, such as a layer, a film, a region, or a substrate, is referred to as being “on” another component, the assembly may be directly on the other component, or an intermediate component may also be present.

The disclosure will be further described in detail with reference to accompanying drawings and preferred embodiments as follows.

In some embodiments, the liquid crystal display panel of the present application may be a curved display panel, and the liquid crystal display device of the present application may also be a curved display device.

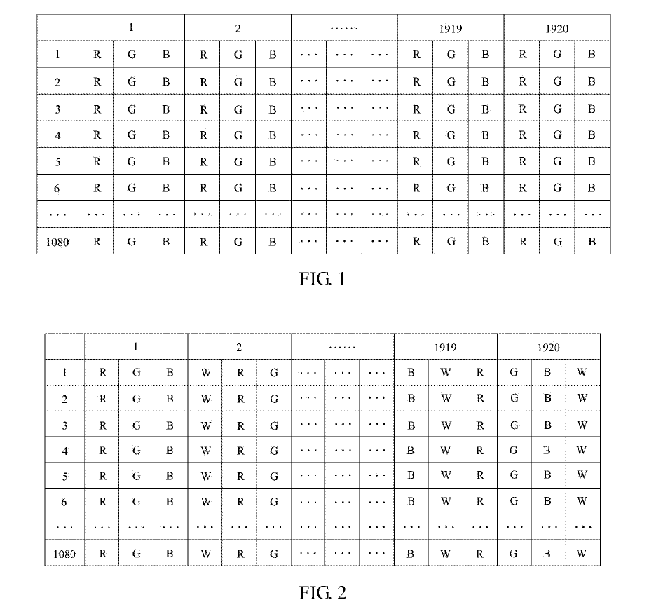

FIG. 1 is a schematic diagram of a RGB pixel structure in the embodiment; and FIG. 2 is a schematic diagram of a RGBW pixel structure in the embodiment. Referring to FIG. 1 and FIG. 2, the total number of sub-pixels (dots) of the RGBW pixel structure is the same as the total number of sub-pixels of the RGB pixel structure, and both the total number thereof is 1080*1920.

Thus, the pure color sub-pixels of the RGBW pixel structure (e.g., red (R) sub-pixels, green (G) sub-pixels, blue (B) sub-pixels) are only 75% of the pure color sub-pixels of the RGB pixel structure. In the case of R sub-pixels, the number of R sub-pixels in the conventional exemplary RGB pixel structure is the total number of dots/3, but in the RGBW pixel structure, the number of R sub-pixel is the total number of dots/4. Therefore, in the RGBW pixel structure, the number of R sub-pixel is only 75% of the RGB pixel structure. Also, because the backlight in the embodiment is a light emitting diode, LED white light source, the W sub-pixels are turned off when it displays a pure color image, so the display device of the RGBW pixel structure displays a pure color image (for example, a pure red image, a pure green image, a pure blue image), only the corresponding RGB sub-pixels are turn on, the display performance is only 75% of the conventional RGB pixel structure, resulting in insufficient display luminance.

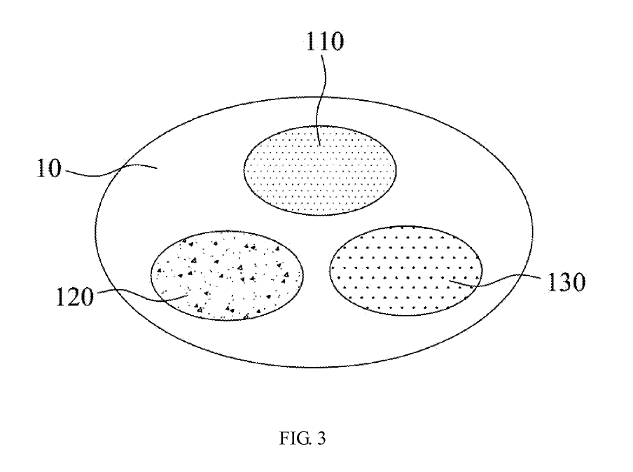

FIG. 3 is a schematic view of a backlight module according to an embodiment of the present application; referring to FIG. 3, in an embodiment of the present application, a backlight module includes a light source 10, the light source 10 has a plurality of light emitting elements, including a first light emitting element 110, a second light emitting element 120, and a third light emitting element 130. The first light emitting element 110 may be, for example, a red light emitting element 110, the second light emitting element 120 may be, for example, a green light emitting element 120, the third light emitting element 130 may be, for example, a blue light emitting element 130.

In one embodiment of the present application, the plurality of light emitting elements 110, 120, 130 are color light emitting diodes (LEDs).

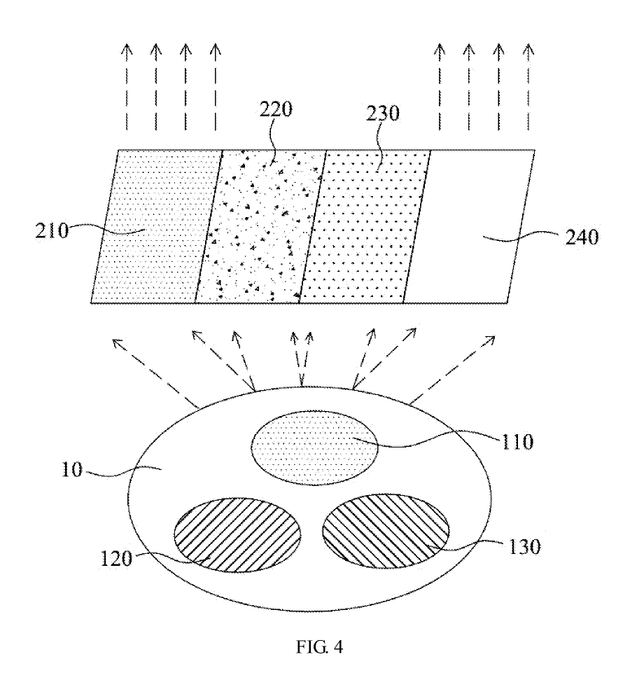

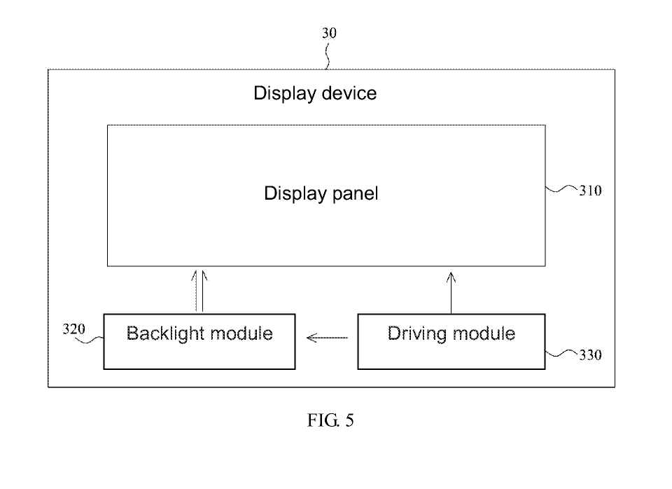

FIG. 4 is a schematic view showing a pixel display of a pure color image according to an embodiment of the present disclosure, and FIG. 5 is a schematic view showing the structure of a display device according to an embodiment of the present application. Also referring to FIGS. 3 to 5, in an embodiment of the present application, a display device 30 includes: a display panel 310 including a plurality of pixels, the pixels including red sub-pixels 210, green sub-pixels 220, blue sub-pixels 230, and white sub-pixels 240; a backlight module 320, the backlight module 320 is disposed opposite to the display panel 3101 wherein the backlight module 320 includes a light source 10, the light source 10 has a plurality of light emitting elements, including a first light emitting element 110, a second light emitting element 120, and a third light emitting element 130; a driving module 330, includes a processing unit, for analyzing data of an image to be displayed; a detection unit for detecting and determining the image to be displayed is a pure color image of one of the three primary colors, the pure color image mixed by at least two of the three primary colors or a color image; a control unit for controlling the light emission state of the plurality of light emitting elements, to emit the light required for the image to be displayed.

In one embodiment of the present application, the plurality of light emitting elements 110, 120, 130 are color light emitting diodes, LEDs.

In one embodiment of the present application, the first light emitting element 110 may be, for example, a red light emitting diode 110, the second light emitting element 120 may be, for example, a green light emitting element 120, the third light emitting element 130 may be, for example, a blue light emitting element 130.

In one embodiment of the present application, the control unit controls the red light emitting diode 110, the green light emitting diode 120, and the blue light emitting diode 130 to be turn on simultaneously or turn on individually. Specifically, the plurality of light emitting diodes 110, 120, 130 may operate independently, or the plurality of light emitting diodes 110, 120, 130 can operate simultaneously, thereby satisfying the image display in a plurality of cases.

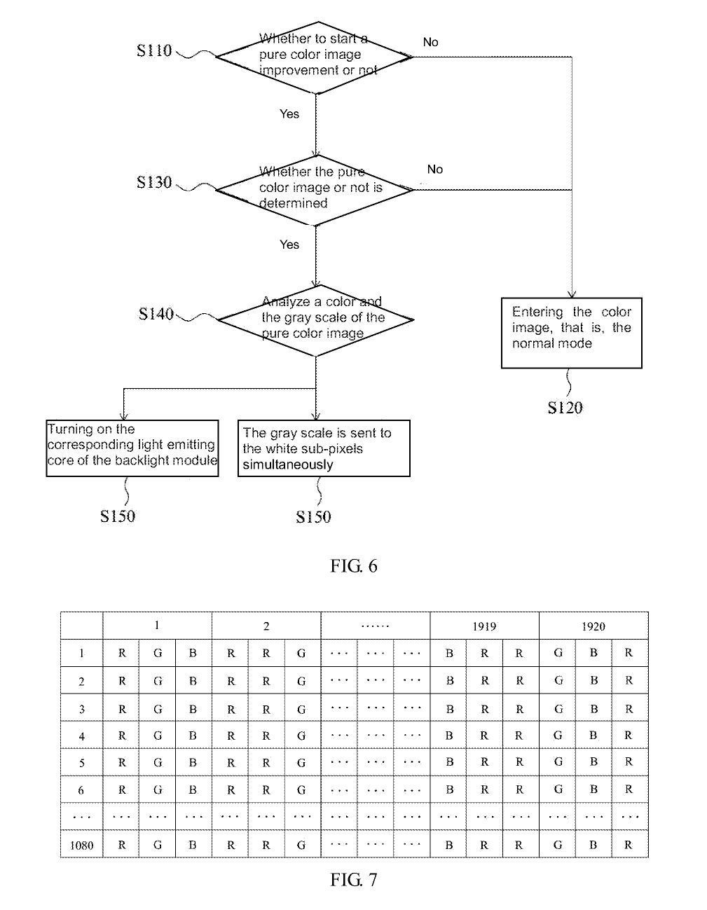

FIG. 6 is a driving flowchart of the display device according to an embodiment of the present disclosure. Referring to FIGS. 3 to 6, in an embodiment of the present application, a driving method of a display device 30 includes: providing the display device 30, if the image to be displayed is a pure color image, by the driving module 330 to control at least one of the light emitting diodes of the plurality of light emitting diodes 110, 120, 130 to be turn on; and if the image to be displayed is a color image, by the driving module 330 to control all of the plurality of light emitting diodes 110, 120, 130 to be turn on to emit a mixing light to be a white light.

Referring to FIG. 6, in one embodiment of the present application, the flow of turn on the pure image includes:

Step S110: deciding whether to start a pure color image improvement or not. The pure color image improvement is a switch of the pure color image enhancement effect, the viewer can select different display effects of the display device 30 according to the demand;

Step S120: if not, displaying the color image, which is the normal mode; if yes, the data of the image to be displayed is analyzed by the processing unit.

Step S130: whether the pure color image or not is determined. By the detection unit to detect and determine the image to be displayed is the pure color image or the color image. If it is a color image, which is the normal mode, presenting the image to be displayed by the control unit; if it is a pure color image, it goes to the next step of pure color image analysis.

Step S140: analyze a color and the gray scale of the pure color image. Performing the analysis to the color and the gray scale of the pure color image by the control unit, to determine an image effect of the image to be displayed.

Step S150: Turning on the corresponding light emitting element of the backlight module, the gray scale is sent to the white sub-pixels simultaneously. Controlling the plurality of light emitting elements (may be exemplified as light emitting diodes) by the control unit to emit light, to present the pure color image, thereby enhancing the display performance of the pure color image.

In the embodiment of the present application, the on and the off states of the red sub-pixels 210, the green sub-pixels 220, the blue sub-pixels 230 are respectively corresponding to the on and the off states of the red light emitting diode 110, the green light emitting diode 120, the blue light emitting diode 130.

In the embodiment of the present application, if the presented color of the pure color image is one color of red, green, and blue, The core of one of the red light emitting diode 110, the green light emitting diode 120, and the blue light emitting diodes 130 is corresponding turned on, the other light emitting diodes are turned off, and the sub-pixels corresponding to the core and the white sub-pixels 240 are turned on, to reveal and form the pure color image.

In the embodiment of the present application, if the color of the pure color image is a color formed by mixing at least two of red, green and blue colors, corresponding at least two of the red light emitting diode 110, the green light emitting diode 120, the blue light emitting diodes 130 are turned on, and the sub-pixels corresponding to the cores and the white sub-pixels 240 are turned on, to reveal and form the pure color image.

In the embodiment of the present application, if the image to be displayed is a color image, that is, the normal mode, the red light emitting diode 110, the green light emitting diode 120, and the blue light emitting diode 130 are simultaneously turn on, to emit white light in a mixed manner, the corresponding sub-pixels and the white sub-pixels 240 are turned on.

FIG. 7 is a schematic diagram of a pixel structure of a pure color image according to an embodiment of the present disclosure. Based on the technique and features of the present application, taking a red pure color image as an example, the present application is further supplied by the following description. Referring to FIGS. 3 to 7, in an embodiment of the present application, when the driving module detects that the ratio of red color in the image to be displayed is greater than the predetermined value, it is determined that it is a red pure color image; therefore, the red light emitting diode 110 of the backlight module is turn on, the green light emitting diode 120, and the blue light emitting diode 130 are turned off, to thereby expose the red color backlight; and at the same time, among the plurality of sub-pixels structures, the corresponding red sub-pixels 210 and the white sub-pixels 240 are turned on, the green sub-pixels 220 and the blue sub-pixels 230 are turn off; to display the red pure color image by the red sub-pixels 210 and the white sub-pixels 240 (as shown in FIG. 4).

In an embodiment of the present application, the set predetermined value is according to the needs of the actual application, for example, 98% or 90%, and is not limited thereto.

In one embodiment of the present application, the sub-pixels structure of the red pure-color image is shown in FIG. 7, in one embodiment, the white sub-pixels 240 may be equivalent to the red sub-pixels 210, the actual number of the red sub-pixels 210 is one half of the total number of dots. Comparing to the RGB pixel structure in the embodiment, the number of the red sub-pixel is one-third of the total number of dots, the present disclosure improves the transmittance of the red sub-pixels, and the presented red pure-color image can have a higher luminance, the viewer's experience is improved.

In some embodiments, in other situations such as green pure color image or blue pure color images, etc., it may be practicable in accordance with the techniques and features of the present application. Since the present disclosure improves the transmittance of the pixel, it is equivalent to all gray scales, from the darkest to the brightest, and not limited to a gray scale image.

In some embodiments, according to different needs, the plurality of light emitting diodes may be other light emitting diodes of other colors, and even, when the backlight module is a direct illumination type, the plurality of light emitting diodes with different colors may be arranged in different display regions, so that making the display regions to have different display effects, to enhance the display color gamut and experience effect. In addition, in some embodiments, the display panel of the display device may adapting Twisted Nematic, TN, Super Twisted Nematic, STN, Optically Compensated Birefringence, OCB, Vertical Alignment, VA type display panel, but is not limited thereto. The display panel of the display device may be a display panel having a curved panel.

The present disclosure can improve the issue of the insufficiently display luminance of the pure color image by the design of the light source of the backlight module to replace the conventional white light source, and is not limited by the gray scale of the pure color image, and to improve the color gamut and increase the contrast of the display image.

“In some embodiments” and “in various embodiments” are used repeatedly. The term generally does not refer to the same embodiment; but it may also refer to the same embodiment. The words “include”, “have” and “comprise” are synonyms unless they mean other meanings before and after the text.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A display device, comprising:
a display panel, comprising a plurality of pixels, each of the pixels comprising a first sub-pixel, a second sub-pixel, a third sub-pixel, and a fourth sub-pixel;
a backlight module disposed opposite to the display panel;
wherein the backlight module comprises a light source, the light source comprising a plurality of light emitting elements, each of the light emitting elements comprises a first light emitting element, a second light emitting element, and a third light emitting element; and
a driving module, comprising:
a processing unit for analyzing data of an image to be displayed;
a detection unit for detecting and determining whether the image to be displayed being a pure color image or a color image;
a control unit for controlling the light emission state of the plurality of light emitting elements to emit lights required for the image to be displayed.

2. The display device according to claim 1, wherein the plurality of light emitting elements are color light emitting diodes.

3. The display device according to claim 1, wherein the first light emitting element is a red light emitting element, the second light emitting element is a green light emitting element, the third light emitting element is a blue light emitting element.

4. The display device according to claim 3, wherein the control unit controls the red light emitting diode, the green light emitting diode, and the blue light emitting diode to be turn on simultaneously.

5. The display device according to claim 3, wherein the control unit controls the red light emitting diode to be turn on individually.

6. The display device according to claim 3, wherein the control unit controls the green light emitting diode to be turn on individually.

7. The display device according to claim 3, wherein the control unit controls the blue light emitting diode to be turn on individually.

8. A driving method for a display device comprising:
acquiring and analyzing gray scale data of first sub-pixels, second sub-pixels, third sub-pixels, and fourth sub-pixels of an image to be displayed by a processing unit;
detecting and determining the image to be displayed being a pure color image or a color image by a detection unit;
if the display image being the pure color image, at least one of a plurality of light emitting elements being controlled to be turned on by a control unit;
if the display image being the color image, the plurality of light emitting elements being controlled to be turn on to emit white light by the control unit;
wherein the plurality of light emitting elements comprise red light emitting elements, green light emitting elements, and blue light emitting elements.

9. The driving method for a display device according to claim 8, wherein the plurality of light emitting elements are color light emitting diodes.

10. The driving method for a display device according to claim 8, wherein the plurality of light emitting elements comprise a first light emitting element, a second light emitting element, and a third light emitting element.

11. The driving method for a display device according to claim 10, wherein the first light emitting element is a red light emitting diode, the second light emitting element is a green light emitting diode, the third light emitting element is a blue light emitting diode.

12. The driving method for a display device according to claim 11, wherein the control unit controls the red light emitting diode, the green light emitting diode, and the blue light emitting diode to be turn on simultaneously.

13. The driving method for a display device according to claim 11, wherein the control unit controls the red light emitting diode to be turn on individually.

14. The driving method for a display device according to claim 11, wherein the control unit controls the green light emitting diode to be turn on individually.

15. The driving method for a display device according to claim 11, wherein the control unit controls the blue light emitting diode to be turn on individually.

16. The driving method for a display device according to claim 8, wherein a turn on state and a turn off state of the first sub-pixels, the second sub-pixels, the third sub-pixels are corresponding to the turn on state and the turn off state of the red light emitting elements, the green light emitting elements, the blue light emitting elements, respectively.

17. The driving method for a display device according to claim 8, wherein if a presented color of the pure color image is one color of red, green, and blue, the cores of one of the corresponding red light emitting elements, the green light emitting elements, and the blue light emitting elements is controlled to be turned on, the other light emitting elements are turned off by the control unit, and the sub-pixels corresponding to the cores and the white sub-pixels are turned on, to reveal and form the pure color image.

18. The driving method for a display device according to claim 8, wherein if a presented color of the pure color image is a color formed by mixing at least two colors of red, green and blue, at least two of the corresponding red light emitting elements, the green light emitting elements, the blue light emitting elements are controlled to be turned on by the control unit, and the sub-pixels corresponding to the cores and the white sub-pixels are turned on, to reveal and form the pure color image.

19. The driving method for a display device according to claim 8, wherein if the image to be displayed is the color image, the red light emitting elements, the green light emitting elements, and the blue light emitting elements are controlled to be turned on simultaneously by the control unit, to mix emitting light and emitting white light, the corresponding sub-pixels and the white sub-pixels are turned on.

20. A display device comprising:
a display panel, comprising a plurality of pixels, the pixels comprising a first sub-pixel, a second sub-pixel, a third sub-pixel, and a fourth sub-pixel;
a backlight module disposed opposite to the display panel;
a driving module, comprising:
a processing unit for analyzing data of an image to be displayed;
a detection unit for detecting and determining whether the image to be displayed being a pure color image or a color image;
a control unit for controlling the light emission state of the plurality of light emitting elements to emit lights required for the image to be displayed;
wherein the backlight module comprises a light source, the light source comprising a plurality of light emitting elements, each of the light emitting elements comprises a first light emitting element, a second light emitting element, and a third light emitting element;
wherein the first light emitting element is a red light emitting element, the second light emitting element is a green light emitting element, the third light emitting element is a blue light emitting element; and
wherein the control unit controls the red light emitting diode, the green light emitting diode, and the blue light emitting diode to be turn on individually or simultaneously.
